(19) United States
(12) Patent Application Publication
(10) Pub. No.: US 2007/0236679 A1
(43) Pub. Date: Oct. 11, 2007

(54) Phase ranging apparatus and method of phase ranging

(75) Inventors: Yin-Long Luo, Hang-Zhou (CN); Shou-Qing Yang, Hang-Zhou (CN); Song Li, Hang-Zhou (CN)

Correspondence Address: THE WEBB LAW FIRM, P.C., 700 KOPPERS BUILDING, 436 SEVENTH AVENUE, PITTSBURGH, PA, 15219, US

(73) Assignee: ASIA OPTICAL CO., INC., Taichung (TW)

(21) Appl. No.: 11/732,322

(22) Filed: Apr. 3, 2007

(30) Foreign Application Priority Data
Apr. 7, 2006 (TW) 95112363

(51) Int. Cl. G01C 3/08

(52) U.S. Cl. 356/4.01

(57) ABSTRACT

A distance measurement apparatus includes a first and a second optical signal producing units, an optical mixing unit, an electric mixing unit and a processing unit. The first optical signal producing unit includes a first emitting unit to emit a first beam based on a first modulated signal to a target. The second optical signal producing unit includes a second emitting unit to emit a second beam based on a second modulated signal. The optical mixing unit produces an optical mixing signal based on the second beam and a reflected beam of the first beam reflected by the target. The electric mixing unit produces an electric mixing signal based on the first and the second modulated signals. The processing unit calculates a phase difference based on the optical mixing signal and the electric mixing signal to determine a distance between the target and the laser ranging apparatus.

### RELATED APPLICATIONS

The application claims priority to Taiwan Application Serial Number 95112363, filed Apr. 7, 2006, which is herein incorporated by reference.

### BACKGROUND

1. Field of the Invention

The present invention relates to a rangefinder. More particularly, the present invention relates to a method and a circuit of the phase rangefinder that address problems of temperature drift.

2. Description of Related Art

With the developments of electronic technology and the growth of laser semiconductors, handheld or portable phase rangefinders have been commercialized and extensively used in many industries, such as architecture, traffic applications, geographical surveying, interior design, etc. Generally, a handheld phase rangefinder equipped with laser emitters emit visible laser beams so that a person who holds the phase rangefinder can aim the phase rangefinder at targets or objects that are faraway. The phase rangefinder uses built-in detectors to detect laser beams reflected by the objects and compares phase difference between the emitted laser beams and the received reflected laser beams to measure the distance from the objects.

Generally, the detectors of rangefinder use PIN photodiode or APD photodiode (Avalanche photodiode) to transform the received reflected laser beams into electric signals. The phase rangefinder that determines the distance from the targets by measuring phase difference overlaps the received and transformed electric signals with a mixing frequency to form a low frequency measurement signal. Thus, by comparing the phase of the low frequency measurement signal with the phase of a reference signal can determine phase difference between the two signals. The distance from the targets or objects can be calculated through the phase difference. However, this type of rangefinder will be significantly influenced by external temperature variations.

Therefore, there is a need to provide an improved phase rangefinder to mitigate or obviate the aforementioned problems.

### SUMMARY

An embodiment of a ranging apparatus in accordance with the present invention comprises a first optical signal producing unit, a second optical signal producing unit, an optical mixing unit, an electric mixing unit and a processing unit. The first optical signal producing unit comprises a first emitting unit to emit a first beam based on a first modulated signal to a target. The second optical signal producing unit comprises a second emitting unit to emit a second beam based on a second modulated signal. The optical mixing unit produces an optical mixing signal based on the second beam and a reflected beam of the first beam reflected by the target. The electric mixing unit produces an electric mixing signal based on the first and the second modulated signals. The processing unit calculates a phase difference based on the optical mixing signal and the electric mixing signal to determine the distance between the target and the laser ranging apparatus.

An embodiment of a laser ranging apparatus in accordance with the present invention comprises a frequency synthesizer, a first optical signal producing unit, a second optical signal producing unit, an optical mixing unit, a mixer and a processing unit. The frequency synthesizer produces a first and a second modulated signal. The first optical signal producing unit comprises a first emitting unit to emit a first beam based on the first modulated signal to a target. The second optical signal producing unit comprises a second emitting unit to emit a second beam based on the second modulated signal. The optical mixing unit produces an optical mixing signal based on the second beam and a reflected beam of the first beam reflected by the target. The mixer produces an electric mixing signal based on the first and the second modulated signals. The processing unit calculates a phase difference based on the optical mixing signal and the electric mixing signal to determine the distance between the target and the laser ranging apparatus.

An embodiment of a method to find a range in accordance with the present invention comprises steps of emitting a first beam toward a target based on a first modulated signal by a first emitting unit, emitting a second beam based on a second modulated signal by a second emitting unit, producing an optical mixing signal based on a reflected beam of the first beam reflected by the target and the second beam, producing an electric mixing signal based on the first and the second modulated signals, and calculating the phase difference based on the optical mixing signal and the electric mixing signal to determine the range.

### BRIEF DESCRIPTION OF THE DRAWINGS

These and other features, aspects, and advantages of the present invention will become better understood with regard to the following description, appended claims, and accompanying drawings where:

FIG. 1 is a block diagram of a ranging apparatus of an embodiment in accordance with the present invention;

FIG. 2 is a schematic diagram of an optical mixing unit and an electric mixing unit of the ranging apparatus in FIG. 1; and

FIG. 3 is a schematic diagram of optical mixing.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

An embodiment of the present invention uses the theory of frequency difference and measuring phase, and making a measurement signal and a reference signal to go through two symmetrical paths to eliminate the influences of variations of exterior temperature. Thus, measuring precision is improved.

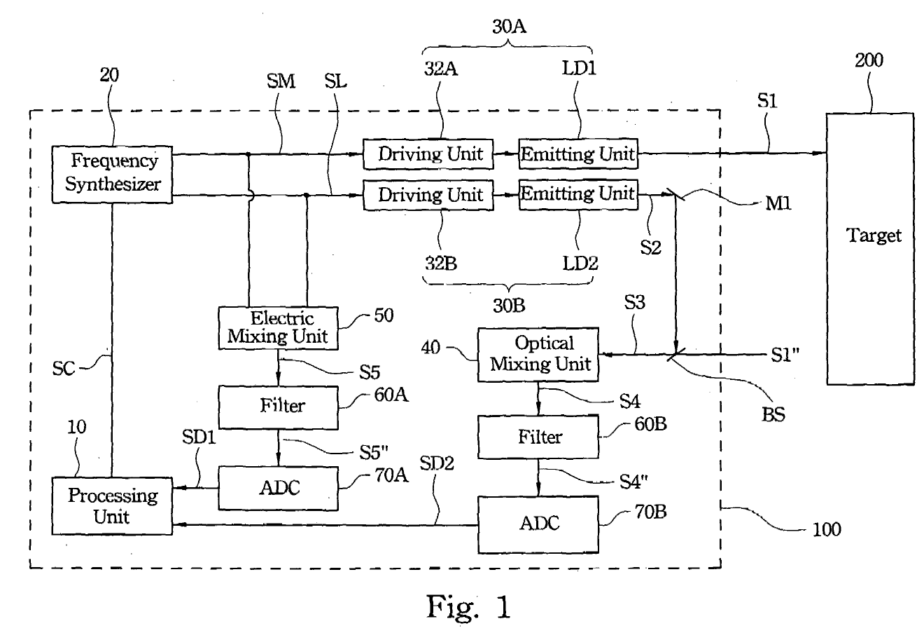

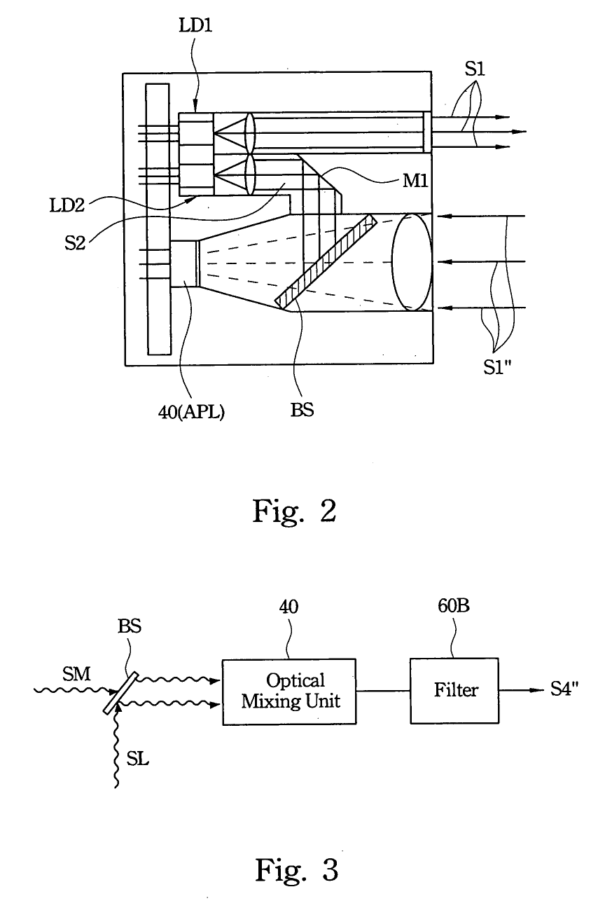

Refer to FIG. 1 and FIG. 2. FIG. 1 and FIG. 2 show an embodiment of a laser ranging apparatus 100 in accordance with the present invention and comprises a processing unit 100, a frequency synthesizer 20, optical signal producing units 30A, 30B, an optical mixing unit 40, an electric mixing unit 50, filters 60A, 60B, analog-to-digital converters (ADC) 70A, 70B, a beam splitter BS and a reflector M1.

The frequency synthesizer 20 is coupled to the processing unit 10 and the optical signal producing units 30A, 30B and produces a master oscillating signal (a first modulated signal) SM and a local oscillating signal (a second modulated signal) SL according to a control signal SC transmitted by the processing unit 10. The frequency of the master oscillating signal SM is ωM, while the frequency of the local oscillating signal is ωL where a phase difference of several KMz exists between the two oscillating signals.

The first optical signal producing unit 30A is used to emit a master oscillating beam (a first beam) S1 toward a target 200 based on the master oscillating signal SM. Likewise, the second optical signal producing unit 30B is used to emit a local oscillating beam (a second beam) S2 based on the local oscillating signal SL. In this embodiment, the optical signal producing units 30A, 30B respectively comprise driving units 32A, 32B and emitting units LD1, LD2. For example, the optical signal producing units 30A, 30B are mutually matched. The emitting units LD1, LD2 may be laser diodes.

The first driving units 32A aims the emitting unit LD1 to emit the master oscillating beams S1 toward the target 200 based on the master oscillating signals SM, and the second driving unit 32B drives the emitting unit LD2 to emit the local oscillating beam S2 based on the local oscillating signal SL as shown in FIG. 2. Further, the local oscillating beam S2 emitted by the second optical signal producing unit 30B is reflected by the reflector M1 towards the beam splitter BS where receiving simultaneously a reflected beam S1″ of the master oscillating beams S1 reflected by the target 200. The reflected beams S1″ of the master and the local oscillating beams S2 are mixed to form an optical signal S3 after the reflected beams S1″ pass through the beam splitter BS and the local oscillating beams S2 reflect from the beam splitter BS. The optical signal S3 is transmitted to the optical mixing unit 40. The reflector M1 may be a high reflection component for the local oscillating beams S2, such as a mirror.

The optical mixing unit 40 receives the optical signal S3 and produces an optical mixing signal S4. For example, the optical mixing unit 40 may be an avalanche photodiode (APD).

The electric mixing unit 50 produces an electric mixing signal S5 based on the master and the local oscillating signals SM, SL. For example, the electric mixing unit 50 may be a mixer.

The first filter 60A is coupled to the electric mixing unit 50 to receive the electric mixing signal S5 and output a low frequency signal S5″. Likewise, the second filter 60B is coupled to the optical mixing unit 40 to receive the optical mixing signal S4 and output a low frequency signal S4″. For example, the filters 60A, 60B may be band-pass filters.

The analog-to-digital converters 70A, 70B are respectively coupled to the filters 60A, 60B to receive the low frequency signals S5″, S4″ and respectively convert the low frequency signals S5″, S4″ into digital signals SD1, SD2. Thus, the processing unit 10 determines the distance between the laser ranging apparatus 100 and the target 200 based on the digital signals SD1, SD2.

In other words, the local oscillating beam S2 and the reflected beam S1″ are mixed, and are transferred into a low frequency signal with a frequency of (ωM−ωL) by the optical mixing unit 40 where the low frequency signal is taken as a measurement signal. On the other hand, the electric mixing unit 50 directly mixes the master and the local oscillating signals SM,SL, and produces a low frequency signal with a frequency of (ω′M−ωL) through the filter 60A, where the low frequency signal is taken as a reference signal.

The processing unit 10 is used to calculate phase difference based on the digital signals SD1 and SD2 to determine the distance between the laser rangefinder 100 and the target 200. For example, the processing unit 10 may be a digital signal processor (DSP). In this embodiment, the processing unit 10 receives the digital signals SD1, SD2 sent by the analog-to digital converters 70A, 70B to calculate phase difference to determine the distance between the laser rangefinder 100 and the target 200.

Refer to FIG. 1 and FIG. 3. The following disclosure describes principles of optical mixing in accordance with the present invention.

According to Maxwell's theory of electromagnetism, light can be considered as an electromagnetic phenomenon with a frequency of about 1014 Hz. When the reflected beam S1″, passed through the beam splitter BS, and the local oscillating beam (the second beam), reflect from the beam splitter BS, enter simultaneously the optical mixing unit 40 (such as the avalanche photodiode, APD), the total electric field intensity in the optical mixing unit 40 would be

E(t)=E_{M} cos (ω_{M}t−φ_{M})+E_{L} cos (ω_{L}t−φ_{L}) (1)

where E_{M}, ω_{M} and φ_{M} are respectively the amplitude, the frequency and the phase of the reflected beam S1″, and E_{L}, ω_{L} and φ_{L} are respectively the amplitude, the frequency and the phase of the local oscillating beam S2. Equation (1) can be rewritten in complex form notation and expressed as

E(t)=E_{M}e^{i(ω}^{_{M}}^{t-φ}^{_{M}}⁾+E_{L}e^{i(ω}^{_{L}}^{t-φ}^{_{L}}⁾ (2)

Since the optical mixing unit 40 is a Square-Law Detector to respond with intensity or power of the beams, in other words, the response (R) of the optical mixing unit 40 is directly proportional to the square of the electric field intensity, which would be expressed as

R∞E(t)·E*(t)=E_{M}²+E_{L}²+2E_{M}E_{L} cos [(ω_{M}−ω_{L})t−φ)] (3)

where, φ=(φM−φL) represents the phase difference between the reflected beam S1″ and the local oscillating beam S2, and the asterisk * represents complex conjugate. The optical mixing unit 40 transforms the received beams into electricity. The power or intensity of the received beams from the optical mixing unit 40 is directly proportional to the square of the intensity of the electric field. Therefore, current output from the optical mixing unit 40 can be expressed as

$$i ( t ) = \frac{η q}{h υ} \{ {P}_{M} + {P}_{L} + 2 \sqrt{{P}_{M} {P}_{L}} cos [ ( {ω}_{M} - {ω}_{L} ) t - φ ) ] \} \qquad ( 4 )$$

where η is quantum yield, q is electron charge, h is Planck's constant, ν is photon frequency, and hν is the energy of a photon. Therefore, the output of the optical mixing unit 40 is a difference frequency signal of the reflected beam S1″ and the local oscillating beam S2.

The following description discloses how to eliminate the temperature drift phenomenon. For convenient purposes only, the reflected beam and S1″ and the local oscillating beam S2 are expressed using the real number part of the above equations.

S1″=A_{M} cos (ω_{M}t+φ_{M}+φ_{d}); (5)

S2=A_{L} cos (ω_{L}t+φ_{L}); (6)

where φd represents phase delay of the reflected beam S1″ after passing through measured distance. Two optical signals with different frequencies are mixed by the same optical mixing unit 40, which produces the difference frequency signal expressed as

$$\begin{matrix}S = S {1}^{″} \cdot S 2 \\ = {A}_{M} cos ( {ω}_{M} t + {φ}_{M} + {φ}_{d} ) \cdot {A}_{L} cos ( {ω}_{L} t + {φ}_{L} ) \\ = \frac{{A}_{M} {A}_{L}}{2} \{ \begin{matrix}cos [ ( {ω}_{M} + {ω}_{L} ) t + ( {φ}_{M} + {φ}_{L} ) + {φ}_{d} ] + \\ cos [ ( {ω}_{M} - {ω}_{L} ) t + ( {φ}_{M} - {φ}_{L} ) + {φ}_{d} ]\end{matrix} \}\end{matrix} \qquad ( 7 )$$

After passing through the band-pass filters, the difference frequency signal would be

S=A cos [(ω_{M}−ω_{L})t+(φ_{M}−φ_{L})+φ_{d})] (8)

Since the master oscillating beam S1 and the local oscillating beam S2 are produced by the frequency synthesizer 20 based on the master oscillating signal SM and the local oscillating signal SL, and by the driving units that drives the emitting units to adjust optical intensity, i.e. amplitude, the temperature of the laser diode, electronic components and variation of environment would cause the phase of the master oscillating signal S1 to vary with temperature variation. The variation of the master oscillating signal S1 causes a phase lag responding to it. In such circumstance, the reflected beam S1″ would be expressed as

S1″=A_{M} cos (ω_{M}t+φ_{M}+φ_{d}+δ); (9)

Since the circuits for processing local oscillating signal SL and the master oscillating signal SM are symmetrical, the same value of phase lag would be simultaneously occurred. In such circumstances, the local oscillating beam S2 would be expressed as

S2=A_{L} cos (ω_{L}t+φ_{L}+δ) (10)

Therefore, after the reflected beam S1″ and the local oscillating beam S2 are mixed by the optical mixing unit 40, and pass through band-pass filter 60B, the difference frequency signal would be

S=A cos [(ω_{M}−ω_{L})t+(φ_{M}−φ_{L})+φ_{d})] (11)

From equation (11), although the temperature variation causes the phase of the master oscillating signal SM to have a phase lag, the local oscillating signal SL would have the same phase lag. Therefore, the phase lags caused by the temperature variation would be mutually canceled so as to eliminate temperature drift. Likewise, before the master oscillating signal SM and the local oscillating signal SL are inputted into the electric mixing unit 50, the paths are also symmetrical. Therefore, the influences of temperature drift after mixing would also be mutually canceled.

The embodiment in accordance with the present invention uses symmetrical circuit design to eliminate temperature drift to increase precision of measurement.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A ranging apparatus comprising
a first optical signal producing unit comprising a first emitting unit to emit a first beam based on a first modulated signal to a target;
a second optical signal producing unit comprising a second emitting unit to emit a second beam based on a second modulated signal;
an optical mixing unit producing an optical mixing signal based on the second beam and a reflected beam of the first beam reflected by the target;
an electric mixing unit producing an electric mixing signal based on the first and the second modulated signals; and
a processing unit calculating a phase difference based on the optical mixing signal and the electric mixing signal to determine a distance between the target and the laser ranging apparatus.

2. The ranging apparatus as claimed in claim 1, wherein the optical mixing unit receives both the reflected beam passing through a beam splitter and the second beam reflected from the beam splitter.

3. The ranging apparatus as claimed in claim 2, wherein the second optical producing unit further comprises a reflector where the second beam is reflected toward the beam splitter.

4. The ranging apparatus as claimed in claim 3, wherein the reflector is a high reflection component relative to the second beam.

5. The ranging apparatus as claimed in claim 1, wherein the first optical producing unit further comprises a first driving unit to drive the first emitting unit to emit the first beam based on the first modulated signal.

6. The ranging apparatus as claimed in claim 5, wherein the second optical producing unit further comprises a second driving unit to drive the second emitting unit to emit the second beam based on the second modulated signal.

7. The ranging apparatus as claimed in claim 1, further comprising a frequency synthesizer to produce the first and the second modulated signals.

8. The ranging apparatus as claimed in claim 1, further comprising
a first filter coupled to the optical mixing unit, receiving the optical mixing signal and outputting a first low frequency signal;
a second filter coupled to the electric mixing unit, receiving the electric mixing signal and outputting a second low frequency signal;
a first and a second analog-to-digital converter receiving respectively the first and the second low frequency signal and converting respectively the first and the second low frequency signal into a first and a second digital signal received by the processing unit to determine the distance.

9. The ranging apparatus as claimed in claim 8, wherein the processing unit is a digital signal processor.

10. The ranging apparatus as claimed in claim 8, wherein each of the first and the second filters is a band-pass filter.

11. The ranging apparatus as claimed in claim 1, wherein the electric mixing unit is a mixer.

12. A method to find a range, and the method comprising
emitting a first beam toward a target based on a first modulated signal by a first emitting unit;
emitting a second beam based on a second modulated signal by a second emitting unit;
producing an optical mixing signal based on the second beam and a reflected beam of the first beam reflected by the target;
producing an electric mixing signal based on the first and the second modulated signals; and
calculating a phase difference based on the optical mixing signal and the electric mixing signal to determine the range.

13. The method claimed in claim 12, further comprising
receiving both the reflected beam passing through a beam splitter and the second beam reflected from the beam splitter by the optical mixing unit.

14. The method as claimed in claim 13, wherein the second beam is reflected toward the beam splitter by a reflector.

15. A ranging apparatus comprising
a frequency synthesizer producing a first and a second modulated signal;
a first optical signal producing unit comprising a first emitting unit to emit a first beam based on the first modulated signal to a target;
a second optical signal producing unit comprising a second emitting unit to emit a second beam based on the second modulated signal;
an optical mixing unit producing an optical mixing signal based on the second beam and a reflected beam of the first beam reflected by the target;
a mixer producing an electric mixing signal based on the first and the second modulated signals; and
a processing unit calculating a phase difference based on the optical mixing signal and the electric mixing signal to determine a distance between the target and the laser ranging apparatus.

16. The ranging apparatus as claimed in claim 15, further comprising
a first filter coupled to the optical mixing unit, receiving the optical mixing signal and outputting a first low frequency signal;
a second filter coupled to the electric mixing unit, receiving the electric mixing signal and outputting a second low frequency signal;
a first and a second analog-to-digital converter receiving respectively the first and the second low frequency signal and converting respectively into a first and a second digital signal received by the processing unit to determine the distance.

17. The ranging apparatus as claimed in claim 16, wherein each of the first and the second filters is a band-pass filter.

18. The ranging apparatus as claimed in claim 15, wherein the processing unit is a digital signal processor.

19. The ranging apparatus as claimed in claim 15, wherein the optical mixing unit receives both the reflected beam passing through a beam splitter and the second beam reflected from the beam splitter.

20. The ranging apparatus as claimed in claim 19, wherein the second beam is reflected toward the beam splitter by a reflector.
